(19) United States
(12) Patent Application Publication
(10) Pub. No.: US 2018/0049409 A1
(43) Pub. Date: Feb. 22, 2018

(54) Pet Identification Collar

(71) Applicant: Joseph S. Sporn, New York, NY (US)

(72) Inventor: Joseph S Sporn, New York, NY (US)

(21) Appl. No.: 15/238,485

(22) Filed: Aug. 16, 2016

(51) Int. Cl. A01K 27/00; A44B 11/25; A44B 11/26; A44B 11/00; G09F 3/20

(52) U.S. Cl. CPC A01K 27/008; A01K 27/001; G09F 3/201; A44B 11/266; A44B 11/005; A44B 11/2592

(57) ABSTRACT

A pet identification collar having a slide buckle is disclosed. The buckle includes a female member having a top surface on which is mounted a container having a transparent top and in which is disposed a slidable tray containing media carrying identification data on the pet wearing the collar.

The present invention relates to pet collars having identification media incorporated into the collar buckle.

### BACKGROUND

The concept of using a pet collar to carry identification of the pet with contact information for the owner if the pet becomes lost or misplaced from the owner has been in the prior art for some time. U.S. Pat. No. 6,374,778 to Glussich discloses a dual collar arrangement where one of the collars carries a separate openable container having therein an identification card. U.S. Pat. No. 7,230,539 to Klein discloses an identification tag with a cavity for insertion of the RF transponder capsule for wireless identification of the pet.

While serving their intended purpose, these and other prior art identification systems for pet collars are cumbersome, expensive and complicated for the one attempting to find the pet's owner.

It is therefore the primary object of the present invention is to provide an identification system for pet collars that is simple and easy to implement and is equally easy and simple to use for the one finding the lost pet and wishing to notify the owner.

### SUMMARY OF THE INVENTION

The identification system of the present invention is incorporated into the body of a slide release buckle that fastens the ends of the collar together. Disposed on the front surface of the female buckle member is an enclosed transparent container having an insertable slidable tray with a recessed portion in which identification media is carried. Information written on the media can be read without having to open the container.

### DESCRIPTION OF THE DRAWINGS

FIG. 1 is a perspective exploded view of the side release collar buckle of the present invention.

FIG. 2 is a perspective view of the side release collar buckle of the present invention in a closed position.

FIG. 3 is a top exploded view of the collar buckle of the present invention.

FIG. 4 is a top view of the collar buckle of the present invention in a closed position.

FIG. 5 is a side elevation of the collar buckle with a partial section.

FIG. 6 is a full longitudinal cross-section through the middle of the buckle taken along lines 6-6 in FIG. 4.

FIG. 7 is a perspective view of a dog wearing the ID collar of the present invention.

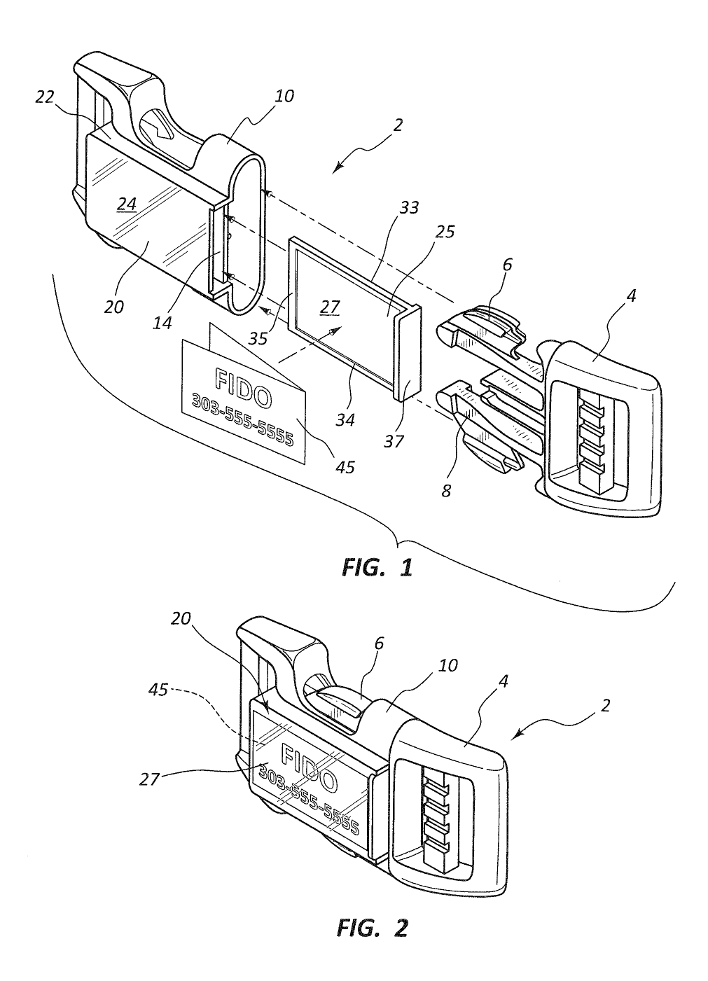

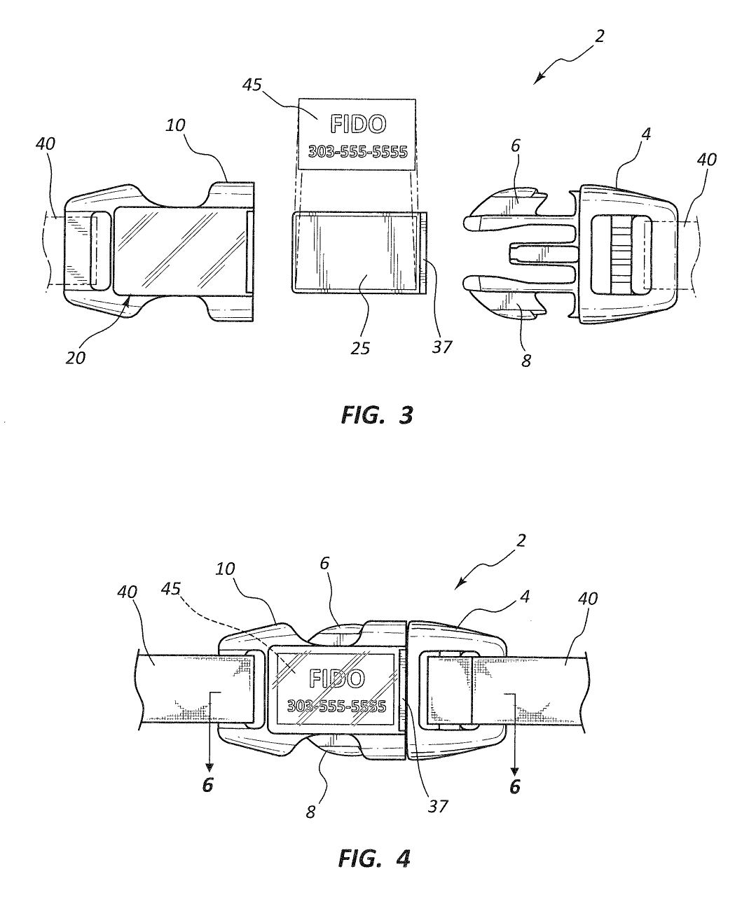

### DETAILED DESCRIPTION OF PREFERRED EMBODIMENT

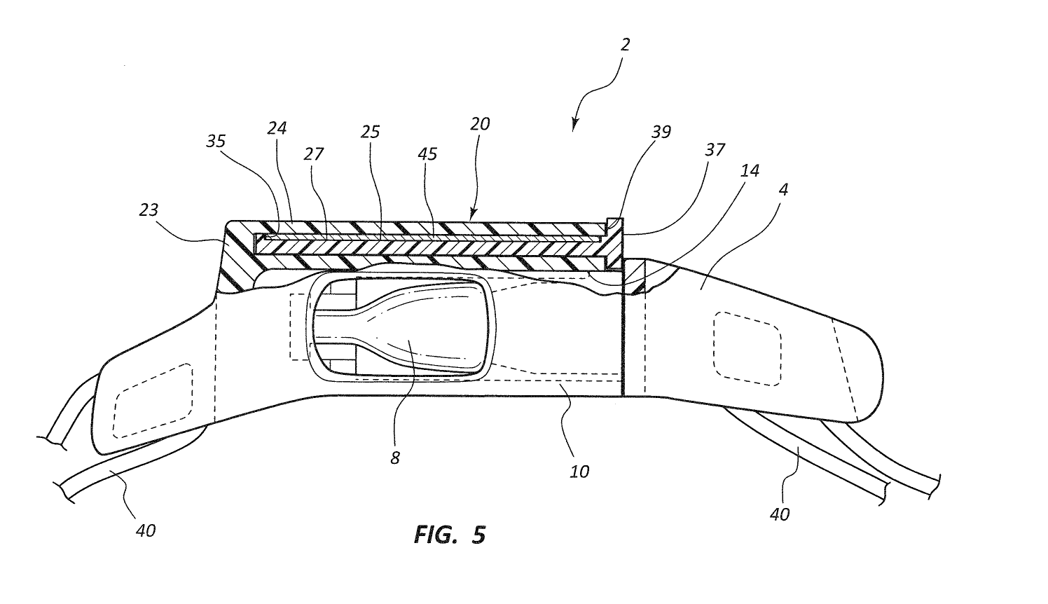

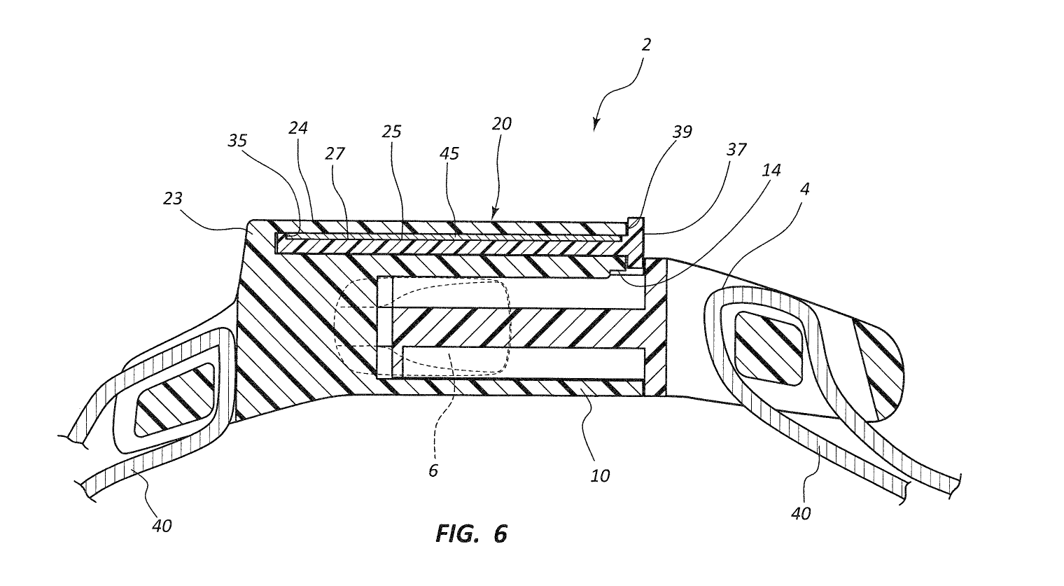

As shown in FIGS. 4-7, the identification collar 40 of the present invention includes a side release buckle 2 having a male member (plug) 4 comprising springable attachment legs 6 and 8 and a female member (socket) 10 into which the legs of the plug are inserted for engagement. On the top surface 14 of the socket 10 there is disposed a rectangular container 20 having side walls 22, a rear wall 23 and a transparent top 24. The bottom, or floor, of the container and be a separate element but preferably the floor of the container is common with, or synonymous with the top surface 14 of the socket 10. The front end of the container, opposite the rear wall 23, is open to allow insertion into the container of a slidable flat tray 25. In the preferred embodiment the bottom 27 of the tray is adapted to slide on the top surface 14 of the socket 10.

Upstanding from the side and rear edges of the rectangular tray 25 are ridges 33, 34 and 35 which are sized and dimensioned to contact the interior side of the top 24 of the container 20. Attached to the front end of the tray is a cover plate 37 having a gasket 39 around its inside edges above and below the bottom 27 of the tray. In addition to sealing the end of the container, the cover plate functions as a finger grip to slide the tray in and out of the container. When the tray is fully inserted into the container the gasket 39 contacts the front edges of the container and the exposed edge of the socket in order to complete a water tight enclosure of the container.

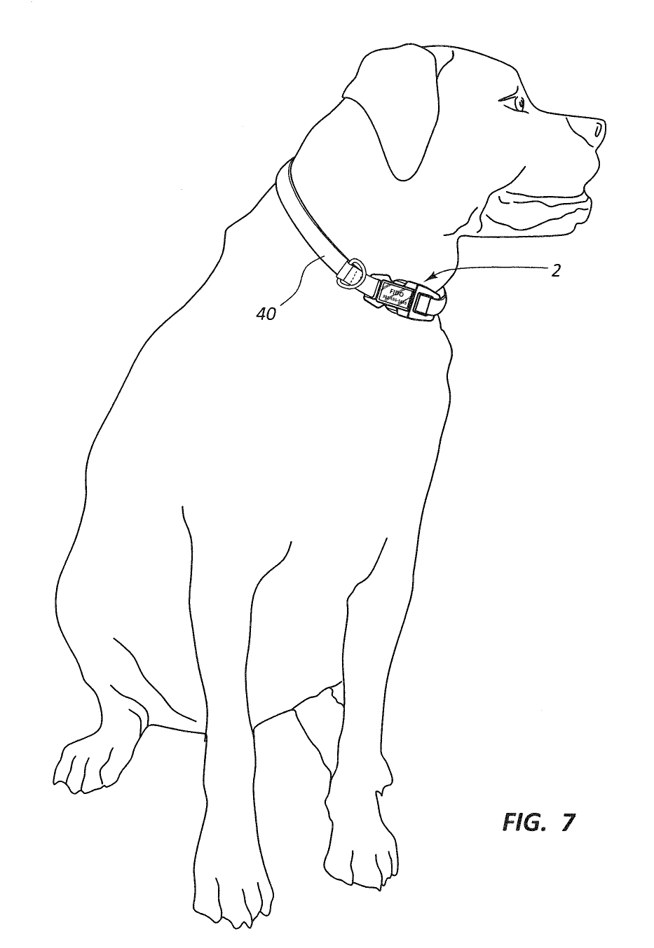

The side release buckle 2 serves to interconnect the ends of a conventional pet collar 40 which is worn around the neck of the pet, as shown in FIG. 7.

In operation, the shallow recess in the tray formed by the cover plate 37 and the edge ridges 33, 34 and 35 is adapted to receive data carrying media, such as a light paper card 45, containing printed information about the animal wearing the ID collar 40. One finding the lost pet has merely to look at the information printed on the paper card 45 to learn of the identification of the animal and its contact information. It is unnecessary to open the container.

I claim:

1. A pet identification collar comprising,
a side release buckle including,
a male buckle member,
a female buckle member having a top surface,
an open ended enclosure disposed on the top surface of the female member and including a top, bottom and lateral side members and a closed end member,
a slidable rectangular tray disposed within the enclosure,
means for identifying the pet carried by the tray, and
a cover plate having inner and outer surfaces and attached to the tray which plate is sized and dimensioned to enclose the open end of the rectangular enclosure.

2. The collar of claim 1 where the top surface of the female member is synonymous with the bottom member of the enclosure.

3. The collar of claim 2 where the tray includes,
mutually parallel lateral sides and first and second ends
a raised second end edge and raised lateral side edges that slidingly engage the top member of the enclosure,

4. The collar of claim 3 and further including,
A gasket attached to the inner surface of the cover plate.

5. The collar of claim 4 where at least the top of the enclosure is transparent.

6. A pet identification collar comprising,
a side release buckle including,
a female buckle member having a top surface,
means for enclosing pet identification data attached to the top surface of the female buckle member.

7. The collar of claim 6 where the means for enclosing pet identification data includes a closable container having a slidable tray therein for carrying the pet identification data.

8. The buckle of claim 7 where at least a portion of the closable container is transparent.

9. A pet identification collar comprising.
a buckle having a top surface,
a container mounted on the top surface of the buckle,
a slidable tray disposed within the container, and
media carried by the tray for identifying the pet wearing the collar.

10. The pet identification collar of claim 9 where the container is at least partially transparent.
